(19) United States
(12) Patent Application Publication
(10) Pub. No.: US 2009/0022227 A1
(43) Pub. Date: Jan. 22, 2009

(54) ADAPTIVE THRESHOLD SIGMA-DELTA ALGORITHM MOVEMENT DETECTION DEVICE AND METHOD

(75) Inventor: Arnaud VERDANT, La Tour De Pin (FR)

Correspondence Address: OBLON, SPIVAK, MCCLELLAND MAIER & NEUSTADT, P.C., 1940 DUKE STREET, ALEXANDRIA, VA, 22314, US

(73) Assignee: COMMISSARIAT A L'ENERGIE ATOMIQUE, Paris (FR)

(21) Appl. No.: 12/172,409

(22) Filed: Jul. 14, 2008

(30) Foreign Application Priority Data
Jul. 16, 2007 (FR) 07 56516

(51) Int. Cl. H04N 7/12

(52) U.S. Cl. 375/240.16; 375/E07.076

(57) ABSTRACT

Movement detection method comprising at least the following steps:
the calculation of an envelope signal Eₙ of a signal Sₙ, designed to be supplied by at least one pixel of a pixel matrix and corresponding to an n-th captured image;
the calculation of a first mean M1ₙ of the signal Eₙ in function of the signal Eₙ and/or M1ₙ₋₁;
the calculation of a signal γₙ=Eₙ×M1ₙ;
the calculation of a second mean M2ₙ of the signal γₙ in function of the signal γₙ and/or M2ₙ₋₁;
the calculation of a third mean M3ₙ of the signal Sₙ in function of the signal Sₙ and/or M3ₙ₋₁ and/or the signal M2ₙ;
the calculation of a signal Δₙ=|Sₙ−M3ₙ|;
a comparison between the signals Δₙ and M2ₙ, wherein a movement is considered as detected when Δₙ>M2ₙ;
where n: natural whole number.

### TECHNICAL FIELD

This document relates to the field of movement detection and more particularly that of image sensors, such as CMOS imaging devices used in the visible or infrared range, wherein a movement detection method is used.

### STATE OF THE PRIOR ART

Movement detection involves detecting the movement of moving elements with respect to fixed elements in a field of captured images. These elements may be for example vehicles or even people. Such movement detection consists of isolating, among the signals supplied by an image sensor, those related to the moving elements, for example by detecting the significant variations on the mean or variance of a signal of a pixel or a group of pixels indicating a change in the nature of the element captured in this pixel or group of pixels, with respect to those related to the fixed elements of which the mean or variance remains for example substantially constant in time. For this purpose, detection methods or algorithms are used.

A first approach consists of using a “recursive average” algorithm for such movement detection. This algorithm is based on an estimated background calculation, which is to say of the fixed elements found in all of the captured images. This is to say Xₙ is the background, or the mean, corresponding to an image n, Sₙ is the signal corresponding to the acquired image n and 1/N is a weighting coefficient, therefore:

$${X}_{n} = {X}_{n - 1} - \frac{1}{N} {X}_{n - 1} + \frac{1}{N} {S}_{n}$$

A comparison is then made between a chosen threshold value Tₕ and |Sₙ−Xₙ|. If the value obtained is positive, this means that a movement has been detected. Xₙ and Sₙ may be variables obtained from a signal supplied by a pixel or by considering several signals supplied by several pixels, for example a group of pixels located next to one another that form a macropixel, like a single signal, taking for example the mean of these signals.

Such an algorithm has especially as disadvantage a lack of robustness in the detection as the detection threshold Tₕ is determined à priori, prior to the algorithm being used, and is global for all of the pixels of the matrix. This disadvantage results in low precision of the location of the movements in the captured images. The low pass type filtering carried out by this algorithm induces dephasing, and consequently a delay in the response with respect to the signal. This delay results in a drag effect which occurs downstream of the passage of a moving element.

A second approach consists of using a “sigma-delta” algorithm for the movement detection. This algorithm permits significant variations of the signal to be detected by calculating two variables that can be assimilated to the mean value and the variance of the signal. FIG. 1 is a diagrammatical representation of a movement detection device using a sigma-delta algorithm.

Firstly, the sigma-delta mean M1ₙ is calculated, with a constant incrementation and decrementation value, for example 1, of the signal Sₙ corresponding to the acquired image n. For this purpose, the signal Sₙ is sent as an input of the first means of calculating the sigma-delta mean 2. These means 2 first carry out an initialisation M1₀=S₀. For the following images, which is to say for n>0, these means 2 compare M1ₙ₋₁ and Sₙ. If M1ₙ₋₁<Sₙ, then the value of M1ₙ₋₁ is incremented such that M1ₙ=M1ₙ₋₁+1. If M1ₙ₋₁>Sₙ, then the value of M1ₙ₋₁ is decremented such that M1ₙ=M1ₙ₋₁−1. The value of the signal Δₙ=|M1ₙ−Sₙ| is calculated by a subtractor 4 and absolute value calculation means 6. The calculation of N×Δₙ is then made by the multiplier 8, wherein N is a constant corresponding to the adaptive threshold of the algorithm whose value is chosen in function of the complexity of the scene. The calculation of a sigma-delta mean M2ₙ of N.Δₙ is then made and sent as an input of second means of calculating the sigma-delta mean 10. Next, the initialisation M2₀=0 is carried out first. For the following images, which is to say for n>0, a comparison is made of M2ₙ₋₁ and N.Δₙ. If M2ₙ₋₁<N.Δₙ, then the value of M2ₙ₋₁ is incremented such that M2ₙ=M2ₙ₋₁+1. If M2ₙ₋₁>N.Δₙ, then the value of M2ₙ₋₁ is decremented such that M2ₙ=M2ₙ₋₁−1. Finally, a comparison is made by a comparator 12 of the signal Δₙ and M2ₙ. If M2ₙ<Δₙ, this means that a movement has been detected.

As for the recursive average algorithm, the variables Sₙ, M1ₙ, Δₙ and M2ₙ may be obtained from a signal supplied by a pixel or by considering several signals supplied by several pixels, for example a group of pixels next to one another, like a single signal, taking for example the mean of these signals.

However, such an algorithm especially has the disadvantage of not filtering high frequency parasite movements which are considered as movements to be detected (for example, a movement of the leaves of a tree or snow falling). Furthermore, the constant N used must be determined à priori, which reduces the adaptability of the detection carried out by this algorithm.

### DESCRIPTION OF THE INVENTION

Thus there is a need to propose a method of movement detection which permits the detection of high frequency parasite movements to be reduced or eliminated and which offers more efficient detection, for example in terms of precision of locating the movements, with respect to the methods of the prior art, and which reduces or eliminates the “drag” effect obtained by the methods of the prior art.

Also, there is a need to propose a method of movement detection which requires few calculation and memory hardware resources to be used, and that can be installed analogically in a very low consumption imaging device (with for example a mean consumption equal to approximately several hundred μW).

For this purpose, one embodiment proposes a method of movement detection comprising at least the following steps:
the calculation of an envelope signal Eₙ of a signal Sₙ, designed to be supplied by at least one pixel of a pixel matrix and corresponding to an n-th captured image, equal to the absolute value of the difference between the signal Sₙ and a value Sₐ, where aε[0;n], corresponding to a final extreme value reached by Sₙ for which the sign of the value

$$\frac{d {S}_{n}}{d n} {\vert}_{n = a}$$

is different from the sign of the value

$$\frac{d {S}_{n}}{d n} {\vert}_{n = a - 1} ,$$

or for which the sign of the value (Sₐ₋₁−Sₐ₋₂) is different from the sign of the value (Sₐ−Sₐ₋₁);
the calculation of a first mean M1ₙ of the signal Eₙ in function of the value of the signal Eₙ and/or a previous value M1ₙ₋₁;
the calculation of a signal γₙ=Eₙ×M1ₙ;
the calculation of a second mean M2ₙ of the signal γₙ in function of the value of the signal γₙ and/or a previous value M2ₙ₋₁;
the calculation of a third mean M3ₙ of the signal Sₙ in function of the value of the signal Sₙ and/or a previous value M3ₙ₋₁ and/or the value of the signal M2ₙ;
the calculation of a signal Δₙ=|Sₙ−M3ₙ|;
a comparison between the signals Δₙ and M2ₙ, wherein a movement is considered as detected when Δₙ>M2ₙ;

where n: natural whole number.

Consequently, a local adaptive movement detection threshold is used, which is to say a threshold specific to each pixel whose value is not constant but based on the activity of the signal from each of the pixels (amplitude, interference frequencies on the signal, . . . ) to determine the presence or absence of movement from significant variations of the signal.

The adaptability of the detection is also improved by eliminating certain constants that had to determined à priori in the methods of the prior art. The sensitivity of the detection is also adapted locally to the activity of the pixels, which is to say individually for each pixel.

When no movement is detected, the value of variations (signal Eₙ) is null or approximately null. The first mean M1ₙ, the product Eₙ.M1ₙ (signal γₙ) and the signal M2ₙ are also approximately null. This method is thus well adapted to realize movement detection in a scene comprising few movements.

Moreover, this method is also adapted to realize movement detection in a scene comprising many movements. Whatever the magnitude of the signal Sₙ occurring during a movement (with for example the value of Sₙ varying from 10 to 100 or from 100 to 1000, and Eₙ thus varying from 0 to 90 or from 0 to 900), a movement detection is realized because the value of |Sₙ−M3ₙ| is greater than the value of M2ₙ during a movement. This movement detection method runs whatever the value of the analyzed signal Sₙ.

The first mean M1ₙ may be obtained at least by the following calculation steps:
M1₀=E₀;

and for n>0:
M1ₙ=M1ₙ₋₁+c₁ when M1ₙ₋₁<Eₙ;
M1ₙ=M1ₙ₋₁−c₁ when M1ₙ₋₁>Eₙ;

where c₁: non-null positive real number.

In one variant, the first mean M1ₙ may be obtained at least from the following equation:

$$M {1}_{n} = M {1}_{n - 1} - \frac{1}{{N}_{1}} M {1}_{n - 1} + \frac{1}{{N}_{1}} {E}_{n} ,$$

where M1₋₁=0, and

1/N₁: non-null positive real number.

The value of the first mean M1ₙ may be greater than a first non-null minimum threshold value S_{M1n}.

The second mean M2ₙ may be obtained at least by the following calculation steps:
M2₀=γ₀;

and for n>0:
M2ₙ=M2ₙ₋₁+c₂ when M2ₙ₋₁<γₙ;
M2ₙ=M2ₙ₋₁−c₂ when M2ₙ₋₁>γₙ;

where c₂: non-null positive real number.

In one variant, the second mean M2ₙ may be obtained at least from the following equation:

$$M {2}_{n} = M {2}_{n - 1} - \frac{1}{{N}_{2}} M {2}_{n - 1} + \frac{1}{{N}_{2}} {γ}_{n} ,$$

where M2₋₁=0, and

1/N₂: non-null positive real number.

The value of the second mean M2ₙ may be greater than a second non-null minimum threshold value S_{M2n}.

Moreover, the value of the second mean M2ₙ may be less than a maximum threshold value, for example comprised between approximately 0.1×the dynamic of the signal Sₙ and 0.2×the dynamic of the signal Sₙ, the dynamic of the signal Sₙ corresponding to the possible maximum value of |Sₙ| (for example equal to 256 for a 8 bits coded signal).

The maximum or minimum threshold values may be imposed to these means during the detection method so that the means value does not exceed these threshold values.

The third mean M3ₙ may be obtained at least by the following calculation steps:
M3₀=S₀;

and for n>0:
M3ₙ=M3ₙ₋₁+M2ₙ when M3ₙ₋₁<Sₙ;
M3ₙ=M3ₙ₋₁−M2ₙ when M3ₙ₋₁>Sₙ.

The value of the third mean M3ₙ may be greater than a third non-null minimum threshold value S_{M3n}.

The calculations of the first mean M1ₙ, the signal γₙ and the second mean M2ₙ may be realized when Eₙ has a non-null value.

The values of the weighting coefficients 1/N, as well as the values of the incrementation and decrementation coefficients c in the case of a sigma-delta type mean calculation, may be calculated in function of the speed of acquisition of the images, and may be easily determined. The time constant τ of a mean may be equal to the ratio: sampling period of the image capture/ln(1−1/N)⁻¹, the sampling period corresponding to the period of the signal Sₙ period (noted period (Sₙ)).

The values of the weighting coefficients 1/N which may be used for the calculation of means M1ₙ and/or M2ₙ may be chosen such that the time constant(s) τ of these means are comprised between approximately 1 second and 10 seconds, or between approximately 1 second and 100 seconds, according to the referred application and/or the speed of the movements to detect.

The values of the incrementation and decrementation coefficients c which may be used for the calculation of means M1ₙ and/or M2ₙ may be chosen and adapted during the method in order to satisfy the relation c<|dSₙ/dn|. In one variant, when the incrementation and decrementation coefficients have fixed values, for example equal to 1, it is possible to adapt a refresh period Tn of the method, that is the period of which the steps of the method are realized, in order to satisfy the relation c<|ΔSₙ/Tn|.

The values of 1/N₁ and/or 1/N₂ may verify the relation: 1 s<période(Sₙ)/ln(1−1/N)⁻¹<100 s;

and/or the values of c₁ and/or c₂ may verify the relation: c<|dSₙ/dn|.

The values of S_{M1n} and/or S_{M2n} and/or S_{M3n} may be comprised between approximately 1/250×the dynamic of the signal Sₙ and 1/25×the dynamic of the signal Sₙ, and for example equal to approximately 1/50×the dynamic of the signal Sₙ.

Another embodiment relates to a movement detection device comprising at least:
means of calculating, or calculator of, an envelope signal Eₙ of a signal Sₙ designed to be supplied by at least one pixel of a pixel matrix and corresponding to an n-th captured image, equal to the absolute value of the difference between the signal Sₙ and a value Sₐ, with aε[0;n], corresponding to a final extreme value reached by Sₙ for which the sign of the value

$$\frac{d {S}_{n}}{d n} {\vert}_{n = a}$$

is different from the sign of the value

$$\frac{d {S}_{n}}{d n} {\vert}_{n = a - 1} ,$$

or for which the sign of the value (Sₐ₋₁−Sₐ₋₂) is different from the sign of the value (Sₐ−Sₐ₋₁);
means of calculating, or a calculator of, a first mean M1ₙ of the signal Eₙ in function of the value of the signal Eₙ and/or a previous value M1ₙ₋₁;
means of calculating, or a calculator of, a signal γₙ=Eₙ×M1ₙ;
means of calculating, or a calculator of, a second mean M2ₙ of the signal γₙ in function of the value of the signal γₙ and/or a previous value M2ₙ₋₁;
means of calculating, or a calculator of, a third mean M3ₙ of the signal Sₙ in function of the value of the signal Sₙ and/or a previous value M3ₙ₋₁ and/or the value of the signal M2ₙ;
means of calculating, or a calculator of, a signal Δₙ=|Sₙ−M3ₙ|;
means of comparing, or a comparator of, the signals Δₙ and M2ₙ, wherein a movement is considered as detected when Δₙ>M2ₙ;

where n: natural whole number.

The means of calculating, or the calculator of, the first mean M1ₙ may at least comprise:
means, or a device, of initialising the value of M1₀ to the value of E₀;
means of comparing, or a comparator of, the value of the signal M1ₙ₋₁ and the value of the signal Eₙ;
means, or a device, of incrementing and decrementing the value of M1ₙ by a constant c₁, where c₁: non-null positive real number.

In one variant, the means of calculating, or the calculator of, the first mean M1ₙ may carry out at least the following operation:

$$M {1}_{n} = M {1}_{n - 1} - \frac{1}{{N}_{1}} M {1}_{n - 1} + \frac{1}{{N}_{1}} {E}_{n} ,$$

where M1₋₁=0, and

1/N₁: non-null positive real number.

The means of calculating, or the calculator of, the second mean M2ₙ may at least comprise:
means, or a device, of initialising the value of M2₀ to the value of γ₀;
means of comparing, or a comparator of, the value of the signal M2ₙ₋₁ and the value of the signal γₙ;
means, or a device, of incrementing and decrementing the value of M2ₙ by a constant c₂, where c₂: non-null positive real number.

In one variant, the means of calculating, or the calculator of, the second mean M2ₙ may carry out at least the following operation:

$$M {2}_{n} = M {2}_{n - 1} - \frac{1}{{N}_{2}} M {2}_{n - 1} + \frac{1}{{N}_{2}} {γ}_{n} ,$$

where M2₋₁=0, and

1/N₂: non-null positive real number.

The means of calculating, or the calculator of, the third mean M3ₙ may at least comprise:
means, or a device, of initialising the value of M3₀ to the value of S₀;
means of comparing, or a comparator of, the value of the signal M3ₙ₋₁ and the value of the signal Sₙ;
means, or a device, of incrementing and decrementing the value of M3ₙ by the value of the second mean M2ₙ.

The means of comparison, or the comparator, may at least comprise an operational amplifier, or transconductance amplifier.

Finally, another embodiment also relates to an image capture device comprising at least one pixel matrix and one movement detection device as previously described.

### BRIEF DESCRIPTION OF THE DRAWINGS

This invention will be more clearly understood upon reading the following description of embodiments provided purely by way of illustration and in no way restrictively, in reference to the appended drawings in which:

FIG. 1 shows diagrammatically a sigma-delta algorithm movement detection device,

FIG. 2 shows diagrammatically an adaptive threshold sigma-delta algorithm movement detection device,

FIG. 3 shows the signals obtained during the calculation of an envelope signal,

FIG. 4 shows the signals obtained during an adaptive threshold sigma-delta algorithm movement detection method,

FIG. 5 shows part of an image capture device comprising an example of an adaptive threshold sigma-delta algorithm movement detection.

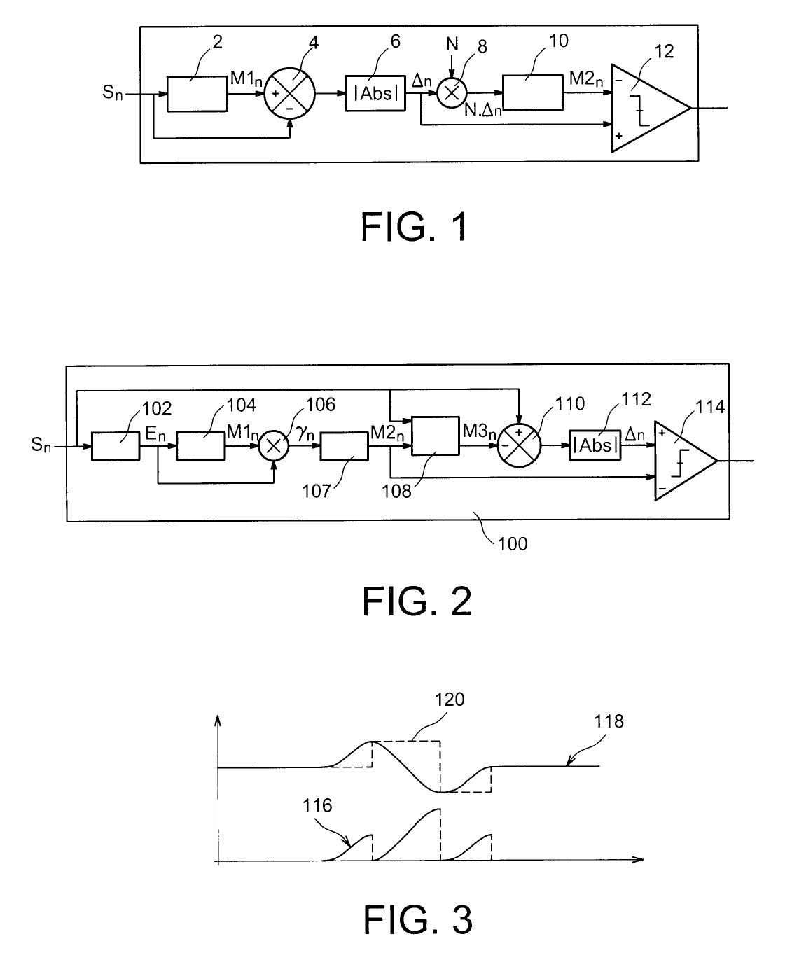

Identical, similar or equivalent parts of the various figures described below have the same numerical references so as to facilitate the passage from one figure to another.

The different parts shown in the figures are not necessarily to a uniform scale, to make the figures easier to read.

The different possibilities (variants and embodiments) should be understood as not being mutually exclusive and may be combined with one another.

### DETAILED DESCRIPTION OF SPECIFIC EMBODIMENTS

An adaptive threshold sigma-delta algorithm movement detection device 100 and method, according to one specific embodiment will now be described in relation to FIG. 2.

A first step of this method is to determine a threshold, which will subsequently be used to determine the presence or absence of movement in the captured images.

Firstly a calculation is made, using calculation means 102, of an envelope signal Eₙ of a signal Sₙ corresponding to the signal supplied by a pixel, or a group of pixels also called macropixel, of an n-th acquired image. The value of this envelope signal Eₙ is equal to the absolute value of the difference between Sₙ and the value of the final extreme value previously reached by the signal Sₙ. This final extreme value corresponds to the last value of the signal Sₙ in which the sign of the derivative

$$\frac{d {S}_{n}}{d n}$$

has changed. FIG. 3 illustrates an example of an envelope signal Eₙ (curve 116) obtained from an example of a signal Sₙ (curve 118). The curve 120 shows the extreme value used to calculate the envelope signal Eₙ. If a value Sₐ is considered, where aε[0;n], corresponding to a final extreme value reached by Sₙ, then this value Sₐ is the value for which the sign of the value

$$\frac{d {S}_{n}}{d n} {\vert}_{n = a}$$

is different from the sign of the value

$$\frac{d {S}_{n}}{d n} {\vert}_{n = a - 1} ,$$

or for which the sign of the value (Sₐ₋₁−Sₐ₋₂) is different from the sign of the value (Sₐ−Sₐ₋₁).

The envelope signal Eₙ obtained is indeed representative of the variations undergone by the output signal Sₙ of a pixel or a macropixel and thus enables the deletion of the direct component of the signal Sₙ.

Then the calculation is made, using calculation means 104, of a first sigma-delta mean M1ₙ with a constant level c₁ of incrementation and decrementation (for example 1 if the value of M1ₙ is within a range of values of levels of grey) of the envelope signal Eₙ. The calculation of this first mean M1ₙ permits the mean of the signal variations to be calculated, which is to say the mean deviation of dispersions, which can be expressed as the mean of differences between the signal value and his mean. For this purpose, the incrementation and decrementation value c₁ chosen is low (in this case 1).

To calculate this first mean M1ₙ, firstly the initialisation M1₀=E₀ is carried out. For the following images, which is to say for n>0, M1ₙ₋₁ and Eₙ are compared. If M1ₙ₋₁<Eₙ, then the value of M1ₙ₋₁ is incremented such that M1ₙ=M1ₙ₋₁+c₁. If M1ₙ₋₁>Eₙ, then the value of M1ₙ₋₁ is decremented such that M1ₙ=M1ₙ₋₁−c₁.

It is also possible that this first mean M1ₙ is not a sigma-delta type mean, but a recursive type mean. In this case, the calculation means 104 calculate the first recursive mean M1ₙ with a high weighting coefficient 1/N₁, of the signal Eₙ. This first recursive mean M1n is obtained with the following calculation:

$$M {1}_{n} = M {1}_{n - 1} - \frac{1}{{N}_{1}} M {1}_{n - 1} + \frac{1}{{N}_{1}} {E}_{n}$$

The value of the weighting coefficient 1/N₁ is especially chosen in function of the amplitude and the frequency of the variations of the envelope signal Eₙ. For example N₁=2⁶ for image captured at around 25 Hz.

The signals M1ₙ and Eₙ are then sent to the input of a multiplier 106 which calculates the signal γₙ=M1ₙ×Eₙ.

Then the calculation is made, using calculation means 107, of a second sigma-delta mean M2ₙ with a constant level c₂ of incrementation and decrementation (for example equal to 1) of the signal γₙ.

To calculate this second mean M2ₙ, firstly the initialisation M2₀=γ₀ is carried out. For the following images, which is to say for n>0, M2ₙ₋₁ and γₙ are compared. If M2ₙ₋₁<γₙ, then the value of M2ₙ₋₁ is incremented such that M2ₙ=M2ₙ₋₁+c₂. If M2ₙ₋₁>γₙ, then the value of M2ₙ₋₁ is decremented such that M2ₙ=M2ₙ₋₁−c₂.

It is also possible that this second mean M2ₙ is not a sigma-delta type mean, but a recursive type mean. In this case, the calculation means 107 calculate the second recursive mean M2ₙ with a high weighting coefficient 1/N₂, of the signal γₙ. This second recursive mean M2ₙ is obtained by the following calculation:

$$M {2}_{n} = M {2}_{n - 1} - \frac{1}{{N}_{2}} M {2}_{n - 1} + \frac{1}{{N}_{2}} {γ}_{n}$$

The value of the weighting coefficient 1/N₂ is chosen in function of the amplitude and the frequency of the variations of the envelope signal γₙ. For example N₂=2⁶ for images captured at around 25 Hz.

Calculation means 108 then calculate a third sigma-delta mean M3ₙ of the signal Sₙ. This third mean M3ₙ is calculated with a non-constant level of incrementation and decrementation. This level of incrementation and decrementation corresponds to the value of the signal M2ₙ. Firstly, the initialisation M3₀=S₀ is carried out. For the following images, M3ₙ₋₁ and Sₙ are compared. If M3ₙ₋₁<Sₙ, then the value of M3ₙ₋₁ is incremented such that M3ₙ₋₁=M3ₙ₋₁+M2ₙ. If M3ₙ₋₁>Sₙ, then the value of M3ₙ₋₁ is decremented such that M3ₙ=M3ₙ₋₁−M2ₙ.

It may therefore be seen that for the calculation of this third mean M3ₙ, the threshold value used to increment and decrement is adaptive in function of variations of the signal Sₙ.

Finally, to determine the presence or absence of movements on the captured image n, a comparison is made between the signal Δₙ=|Sₙ−M3ₙ|, obtained from a subtractor 110 and absolute value calculation means 112, and the signal M2ₙ. If M2ₙ<|Sₙ−M3ₙ|, this means that a movement has been detected in the captured images.

This method is based on the calculation of a sigma-delta mean with constant incrementation and decrementation which varies in function of the variations in the captured images, filtering the high frequency parasite movements. The thresholding of the variations detected is therefore adaptive.

With respect to a recursive type mean, a sigma-delta type mean value has the advantage of not directly depending on the amplitude of the variations of the signal for which the mean is calculated.

In general, the incrementation and decrementation values c₁ and c₂ and/or the weighting coefficient values 1/N₁ and 1/N₂ used in the means calculations are adapted in function of the pixel resolution of the captured images, which is to say the number of levels of grey onto which the processed signal is encoded, as well as the operating frequency of the movement detection device 100.

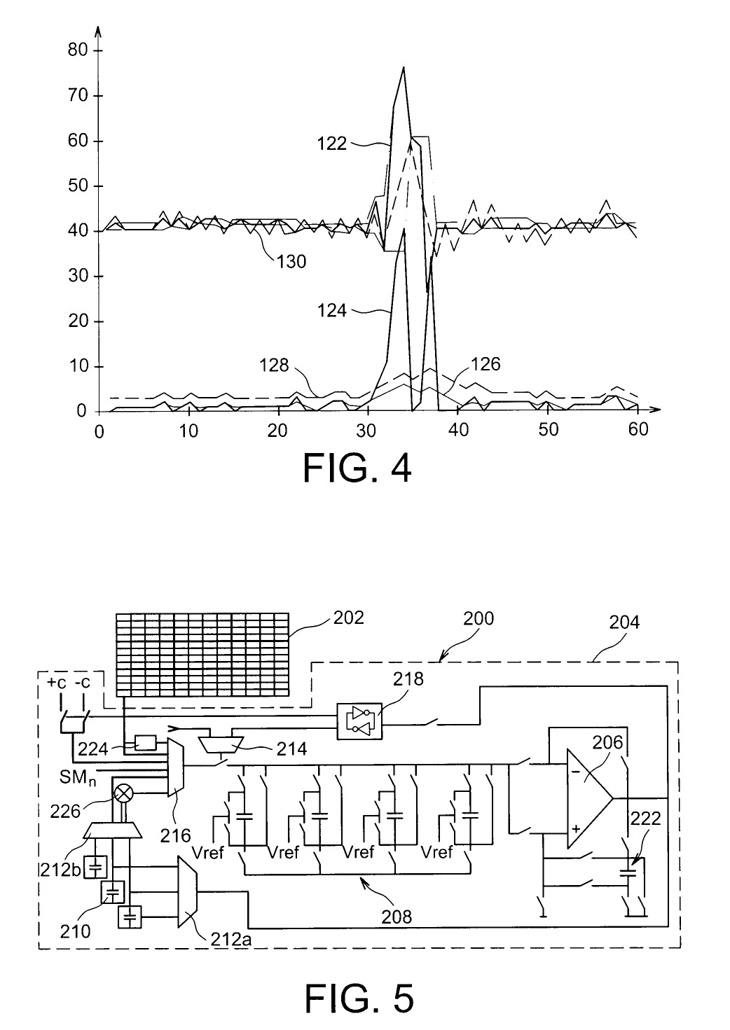

FIG. 4 shows an example of a signal Sₙ from several images captured by a pixel matrix as well as the different signals calculated during the previously described method.

In this FIG. 4, the x axis shows the evolution of the signals, graduated in the number of captured images, and the y axis shows the value of these signals graduated in the levels of grey. The curve 122 shows the signal Sₙ obtained at the output of a pixel or a macropixel. It is this signal that is sent to the input of the device 100. The curve 124 shows the envelope Eₙ of the signal Sₙ calculated during the previously described movement detection method. This envelope signal Eₙ shows the absolute value of the variations of the signal Sₙ with respect to the final extreme value of Sₙ. The curve 126 shows the first mean M1ₙ calculated during the movement detection method. It can be seen in FIG. 4 that this mean M1ₙ follows the most significant variations of the output signal Sₙ. The curves 128 and 130 respectively show the means M2ₙ and M3ₙ.

During the calculations of means M1ₙ and M2ₙ, it is possible to impose a minimum threshold value S_{Mn} below which the mean values are not allowed to drop. For example, in this embodiment, the values of S_{M1n} and/or S_{M2n} may be equal to about 1/50×the dynamic of the signal Sₙ.

One example of an image capture device 200, or optical imaging device, permitting the previously described movement detection method to be implemented is shown in FIG. 5.

The image capture device 200 comprises pixel matrix 202 and a movement detection device 204. Each pixel of the matrix 202 is here formed by a photodiode and addressing and reading transistors. The movement detection method previously described may be applied to the signal Sₙ supplied by a pixel, by connecting a movement detection device similar to the device 204 to each column of pixels of the matrix 202. It is also possible that the movement detection method is applied to a signal Sₙ corresponding to the signals supplied by several pixels, for example the mean of these signals. Consequently, by considering the macropixels, it is possible to operate the image capture device 200 in low resolution zones, and only to detail these zones by using the movement detection method for each pixel of a macropixel when a movement is detected on this macropixel. It is therefore possible to reduce the number of movement detection devices 204 used in the image capture device 200 by only using a single movement detection device 204 per column of macropixels. A macropixel may for example be a square of 12×12 pixels, or any other value, for example 4×4 pixels as in FIG. 5. The values of each macropixel of the matrix 202 are read line by line.

The movement detection devices 204 shown in FIG. 5 comprises a comparator 206, for example an operational amplifier, a plurality of switched capacities 208, analogue memory registers 210 (three memory registers 210 are shown in FIG. 5 but the movement detection device 204 may comprise a different number of memory registers adapted to the number of values to be stored while the movement detection method is in use), an address demultiplexer 212a, an address multiplexer 212b, a multiplexer 214 for controlling the writing in the switched capacities 208, a multiplexer 216 supplying the values to be written in the switched capacities 208, a SRAM memory 218, a capacitor 222, means of calculating 224 an envelope signal and means of multiplying the two signals 226. Finally, the movement detection device 204 comprises several controlled switches permitting the signals of one of the elements previously mentioned to be sent to another of these elements.

The operation of the movement detection device 200 will now be described in relation to the implementation of the movement detection method previously described.

Firstly, the envelope signal Eₙ of the signal Sₙ is calculated, For this purpose, the signal Sₙ supplied at the output of the pixel matrix 202 is sent to the calculation means 224 supplying in output the envelope signal Eₙ whose value is calculated according to the previously described method. The value of the envelope signal is then stored in one of the analogue memory registers 210.

Next, to calculate the first mean M1ₙ, when it is of the sigma-delta type, initialisation M1₀=E₀ is carried out by storing the value of the signal E₀ in one of the memory registers 210. For the following images, M1ₙ₋₁ and Eₙ are compared by applying one of the two signals to the positive input of the comparator 206 by means of the capacitor 222 in which this signal is stored, and by applying the other one of the two signals to the negative input of the comparator 206. The result obtained at the output of the comparator 206 then permits one of the values +c₁ or −c₁ applied to the input of the multiplexer 216 (+c or −c in FIG. 5) to be selected. If M1ₙ₋₁<Eₙ, then the value of M1ₙ₋₁ is incremented such that M1ₙ=M1ₙ₋₁+c₁. If M1ₙ₋₁>Eₙ, then the value of M1ₙ₋₁ is decremented such that M1ₙ=M1ₙ₋₁−c₁. In this embodiment, c₁=1. The addition or subtraction operation of c₁ to M1ₙ₋₁ is carried out using capacities 208 by storing at the terminals of two of these capacities the values +/−c₁ and M1ₙ₋₁, and by connecting these capacities in series so as to add these two values.

In one variant, the first mean M1ₙ may be of the recursive type and be calculated from the following equation:

$$M {1}_{n} = M {1}_{n - 1} - \frac{1}{{N}_{1}} M {1}_{n - 1} + \frac{1}{{N}_{1}} {S}_{n} ,$$

For this purpose, the signal Mₙ₋₁ (where M₋₁=0) is sent to the terminals of a first switched capacity 208 whose value is equal to (N₁−1)/N₁. The value of the signal Mₙ₋₁ is stored at the terminals of this switched capacity.

The signal Sₙ supplied by the first macropixel of the matrix 202 to the input of the multiplexer 216 is then read. The value of the signal Sₙ is stored at the terminals of a second switched capacity whose value is equal to 1/N₁.

By connecting in parallel these two switched capacities, the signal

$$M {1}_{n} = M {1}_{n - 1} - \frac{1}{{N}_{1}} M {1}_{n - 1} + \frac{1}{{N}_{1}} {S}_{n}$$

is indeed obtained at their terminals.

The value of the mean M1ₙ is then stored in one of the memory registers 210.

Next, to obtain the signal γₙ, the product of Eₙ×M1ₙ is calculated. For this purpose, the two values of Eₙ and M1ₙ stored in the memory registers 210 are sent to the two inputs of the multiplication means 226, wherein the result of this multiplication may then be stored in one of the memory registers 210.

In a similar manner to the calculation of the first mean M1ₙ of the envelope signal Eₙ, the calculation of the second mean M2ₙ of the signal γₙ is carried out. As for the first mean M1ₙ, the second mean M2ₙ may be of the sigma-delta or recursive type. This calculation is implemented by the same elements of the device 204 as those used to calculate the first mean M1ₙ when M1ₙ and M2ₙ are of the same type.

Next the calculation of the third sigma-delta mean M3ₙ of the signal Sₙ is carried out with an incrementation and decrementation value of M2ₙ. This calculation is implemented by the same elements of the device 204 as those used to calculate the first mean M1ₙ when the latter is of the sigma-delta type.

Next the calculation of the signal Δₙ=|Sₙ−M3ₙ| is carried out. This operation may be carried out using switched capacities 208.

A comparison is then made using the amplifier 206 of the signal Δₙ and the signal M2ₙ. The value obtained at the output of the amplifier 206 permits the detection or non-detection of a movement on the macropixel considered. If Δₙ>M2ₙ, then it is considered that a movement has been detected on the macropixel considered. This value obtained at the output of the amplifier 206 may be stored in the memory 218.

The operation is then repeated for the following macropixels, line after line.

During all of the calculations of the means M1ₙ and M2ₙ, a minimum threshold value may be imposed, below which the values of these means are not allowed to descend. This minimum threshold value S_{Mn} may be applied to the input of the multiplexer 216. When the value of one of these means drops below this threshold value, the value of this mean is then replaced by the threshold value. This threshold value may be different according to whether it is M1ₙ or M2ₙ that is calculated. In this case, several minimum non-null threshold values S_{M1n} and S_{M2n} may be applied to the input of the multiplexer 216. Moreover, a maximum threshold value may be imposed above which the value of the second mean M2n is not allowed to rise. When the value of M2ₙ exceeds the value of this maximum threshold, the value of this mean M2ₙ is replaced by the threshold value, for example applied to the input of the multiplexer 216.

When a movement is detected on the macropixel, it is possible, for an image n for which the movement detection has been carried out on macropixels, to store the values of the macropixels in the memory 218, then, on the macropixel(s) where movements are recorded, to implement the movement detection method previously described for each of the pixels of the macropixel. Consequently, the location of the movements detected may be defined precisely, without processing all of the pixels of the captured images.

It may be seen that the method may be implemented using few hardware calculation (an operational amplifier, several switched capacities with a clock frequency for the instructions of several tens of kHz and several multiplexers/demultiplexers) and memory resources (several analogue registers per pixel and a SRAM memory for example).

The device shown in FIG. 5 permits an analogue implementation of the movement detection method previously described. However, it is also possible to use a digital implementation of the movement detection method by connecting the pixel matrix 202 to signal digital processing means, for example a circuit of the DSP or FPGA type or a microprocessor, wherein the movement detection method is programmed.

The signals obtained at the output of the movement detection devices may be used to display an image on which the background captured forms a black background onto which the moving elements detected are shown in white.

1. A movement detection method comprising at least the following steps:
the calculation of an envelope signal Eₙ of a signal Sₙ, designed to be supplied by at least one pixel of a pixel matrix and corresponding to an n-th captured image, equal to the absolute value of the difference between the signal Sₙ and a value Sₐ, where aε[0;n], corresponding to a final extreme value reached by Sₙ for which the sign of the value
$$\frac{d {S}_{n}}{d n} {\vert}_{n = a}$$
is different from the sign of the value
$$\frac{d {S}_{n}}{d n} {\vert}_{n = a - 1} ;$$
the calculation of a first mean M1ₙ of the signal Eₙ in function of the value of the signal Eₙ and/or a previous value M1ₙ₋₁;
the calculation of a signal γₙ=Eₙ×M1ₙ;
the calculation of a second mean M2ₙ of the signal γₙ in function of the value of the signal γₙ and/or a previous value M2ₙ₋₁;
the calculation of a third mean M3ₙ of the signal Sₙ in function of the value of the signal Sₙ and/or a previous value M3ₙ₋₁ and/or the value of the signal M2ₙ;
the calculation of a signal Δₙ=|Sₙ−M3ₙ|;
a comparison between the signals Δₙ and M2ₙ, wherein a movement is considered as detected when Δₙ>M2ₙ;
where n: natural whole number.

2. The method according to claim 1, wherein the first mean M1ₙ is obtained at least from the following calculation steps:
M1₀=E₀;
and for n>0:
M1ₙ=M1ₙ₋₁+c₁ when M1ₙ₋₁<Eₙ;
M1ₙ=M1ₙ₋₁−c₁ when M1ₙ₋₁>Eₙ;
where c₁: non-null positive real number.

3. The method according to claim 1, wherein the first mean M1ₙ is obtained at least from the following equation:
$$M {1}_{n} = M {1}_{n - 1} - \frac{1}{{N}_{1}} M {1}_{n - 1} + \frac{1}{{N}_{1}} {E}_{n} ,$$
where M1₋₁=0, and
1/N₁: non-null positive real number.

4. The method according to claim 1, wherein the second mean M2ₙ is obtained at least from the following calculation steps:
M2₀=γ₀;
and for n>0:
M2ₙ=M2ₙ₋₁+c₂ when M2ₙ₋₁<γₙ;
M2ₙ=M2ₙ₋₁−c₂ when M2ₙ₋₁>γₙ;
where c₂: non-null positive real number.

5. The method according to claim 1, wherein the second mean M2ₙ is obtained at least from the following equation:
$$M {2}_{n} = M {2}_{n - 1} - \frac{1}{{N}_{2}} M {2}_{n - 1} + \frac{1}{{N}_{2}} {γ}_{n} ,$$
where M2₋₁=0, and
1/N₂: non-null positive real number.

6. The method according to claim 1, wherein the third mean M3ₙ is obtained at least from the following calculation steps:
M3₀=S₀;
and for n>0:
M3ₙ=M3ₙ₋₁+M2ₙ when M3ₙ₋₁<Sₙ;
M3ₙ=M3ₙ₋₁−M2ₙ when M3ₙ₋₁>Sₙ.

7. The method according to claim 1, wherein the value of the first mean M1ₙ is greater than a first non-null minimum threshold value S_{M1n} and/or the value of the second mean M2ₙ is greater than a second non-null minimum threshold value S_{M2n}.

8. The method according to claim 7, wherein the values of S_{M1n} and/or S_{M2n} are comprised between approximately 1/250×the dynamic of the signal Sₙ and 1/25×the dynamic of the signal Sₙ.

9. The method according to claim 1, wherein the value of the second mean M2ₙ is less than a maximum threshold value comprised between approximately 0.1×the dynamic of the signal Sₙ and 0.2×the dynamic of the signal Sₙ.

10. The method according to claim 1, wherein the calculations of the first mean M1ₙ, the signal γₙ and the second mean M2ₙ are realized when Eₙ has a non-null value.

11. The method according to claim 1, wherein the values of 1/N₁ and/or 1/N₂ verify the relation:
1 s<période(Sₙ)/ln(1−1/N)⁻¹<100 s;
and/or the values of c₁ and/or c₂ verify the relation:
c<|dSₙ/dn|.

12. A movement detection device comprising at least:
means of calculating an envelope signal Eₙ of a signal Sₙ designed to be supplied by at least one pixel of a pixel matrix and corresponding to an n-th captured image, equal to the absolute value of the difference between the signal Sₙ and a value Sₐ, with aε[0;n], corresponding to a final extreme value reached by Sₙ for which the sign of the value
$$\frac{d {S}_{n}}{d n} {\vert}_{n = a}$$
is different from the sign of the value
$$\frac{d {S}_{n}}{d n} {\vert}_{n = a - 1} ;$$
means of calculating a first mean M1ₙ of the signal Eₙ in function of the value of the signal Eₙ and/or a previous value M1ₙ₋₁;
means of calculating a signal γₙ=Eₙ×M1ₙ;
means of calculating a second mean M2ₙ of the signal γₙ in function of the value of the signal γₙ and/or a previous value M2ₙ₋₁;
means of calculating a third mean M3ₙ of the signal Sₙ in function of the value of the signal Sₙ and/or a previous value M3ₙ₋₁ and/or the value of the signal M2ₙ
means of calculating a signal Δₙ=|Sₙ−M3ₙ|;
means of comparing the signals Δₙ and M2ₙ, wherein a movement is considered as detected when Δₙ>M2ₙ;
where n: natural whole number.

13. The device according to claim 12, wherein the means of calculating the first mean M1ₙ comprise at least:
means of initialising the value of M1₀ to the value of E₀;
means of comparing the value of the signal M1ₙ₋₁ and the value of the signal Eₙ;
means of incrementing and decrementing the value of M1ₙ by a constant c₁, where c₁: non-null positive real number.

14. The device according to claim 12, wherein the means of calculating the first mean M1ₙ at least carry out the following operation:
$$M {1}_{n} = M {1}_{n - 1} - \frac{1}{{N}_{1}} M {1}_{n - 1} + \frac{1}{{N}_{1}} {E}_{n} ,$$
where M1₋₁=0, and
1/N₁: non-null positive real number.

15. The device according to claim 12, wherein the means of calculating the second mean M2ₙ at least comprise:
means of initialising the value of M2₀ to the value of γ₀;
means of comparing the value of the signal M2ₙ₋₁ and the value of the signal γₙ;
means of incrementing and decrementing the value of M2ₙ by a constant c₂, where c₂: non-null positive real number.

16. The device according to claim 12, wherein the means of calculating the second mean M2ₙ at least carry out the following operation:
$$M {2}_{n} = M {2}_{n - 1} - \frac{1}{{N}_{2}} M {2}_{n - 1} + \frac{1}{{N}_{2}} {γ}_{n} ,$$
where M2₋₁=0, and
1/N₂: non-null positive real number.

17. The device according to claim 12, wherein the means of calculating the third mean M3ₙ at least comprise:
means of initialising the value of M3₀ to the value of S₀;
means of comparing the value of the signal M3ₙ₋₁ and the value of the signal Sₙ;
means of incrementing and decrementing the value of M3ₙ by the value of the second mean M2ₙ.

18. An image capture device comprising at least one pixel matrix and one movement detection device according to claim 12.
